(19) United States
(12) Patent Application Publication
(10) Pub. No.: US 2008/0277596 A1
(43) Pub. Date: Nov. 13, 2008

(54) Impact Indicating Microcapsules

(75) Inventor: James D. OXLEY, San Antonio, TX (US)

Correspondence Address: GROSSMAN, TUCKER, PERREAULT & PFLEGER, PLLC, 55 SOUTH COMMERICAL STREET, MANCHESTER, NH, 03101, US

(73) Assignee: SOUTHWEST RESEARCH INSTITUTE, San Antonio, TX (US)

(21) Appl. No.: 11/745,716

(22) Filed: May 8, 2007

(51) Int. Cl. F21K 2/00

(52) U.S. Cl. 250/462.1

(57) ABSTRACT

The present disclosure is directed at an impact indictor that may be coated on a structure to detect impacts thereon. The indicator may be provided within microcapsules. Upon rupture of the microcapsules, the indicator may be exposed to a pH activator, wherein the indicator may then exhibit fluorescence upon exposure to electromagnetic energy.

### GOVERNMENT RIGHTS CLAUSE

This invention was made with government support under FA8650-05-C-5043 awarded by the United States Air Force Research Laboratory. The government has certain rights in the invention.

### FIELD OF INVENTION

The present invention relates to impact indicators and in particular, a microcapsule that contains an indicator that may be released due to a mechanical force and which may provide fluorescence in the presence of a light source. Such microcapsules may therefore be incorporated into an impact indicating coating and may identify the location of an impact force.

### BACKGROUND

Due to the complexities and size of certain structures, damage may be difficult to detect upon cursory visual inspection. Impact indicators may therefore assist in initially detecting portions of a material or surface that may have experienced impact or other form of mechanical damage. Such indicators may be particularly useful as applied to substrates which may quickly deteriorate in performance and which may be important to detect and remedy as soon as impact damage has occurred.

### SUMMARY

In a first exemplary embodiment, the present disclosure relates to a composition capable of detecting impact upon a structure. The composition may include microcapsules containing a fluorescent indicator capable of fluorescence, wherein the fluorescent indicator is capable of a first fluorescence intensity (F₁) at a pH of about 7.0 and a second fluorescence intensity (F₂) at a pH value of less than 7.0, wherein F₂>F₁. Microcapsules may be included containing the pH activator, wherein the pH activator, upon release from its microcapsule is capable of providing a pH environment of <7.0 for the fluorescent indicator.

In another exemplary embodiment, the present disclosure again relates to a composition capable of detecting impact upon a structure. The composition may again include microcapsules containing a fluorescent indicator capable of fluorescence, wherein the fluorescent indicator is capable of a first fluorescence intensity (F₁) at a pH of about 7.0 and a second fluorescence intensity (F₂) at a pH value of less than 7.0, wherein F₂>F₁. Such microcapsules may then be mixed in a liquid coating medium containing a pH activator, wherein the pH activator is capable of providing a pH environment of <7.0 for the fluorescent indicator when released from the microcapsules.

In yet another exemplary embodiment, the present disclosure relates to a method for revealing an impact received by a structure. Initially, one may apply to the surface of the structure microcapsules containing a fluorescent indicator capable of fluorescence wherein the fluorescent indicator is capable of a first fluorescence intensity (F₁) at a pH of about 7.0 and a second fluorescence intensity (F₂) at a pH value not equal to 7.0, wherein F₂>F₁. A A pH activator is then made available wherein the pH activator is capable of providing a pH environment not equal to 7.0 for said fluorescent indicator. Upon release of the fluorescent indicator from the microcapsules an area of impact is identified by exposure of the fluorescent indicator to electromagnetic energy to provide fluorescence.

### BRIEF DESCRIPTION OF DRAWINGS

The detailed description below may be better understood with reference to the accompanying figures which are provided for illustrative purposes and are not to be considered as limiting any aspect of the invention.

FIG. 1 is an exemplary flow chart illustrating the process of impact indication of the present disclosure;

FIG. 2 is an optical micrograph of exemplary microcapsules produced by interfacial polymerization at 500× magnification with a scale line at 10 μm.

FIG. 3 is an optical micrograph of exemplary microcapsules produced by simple coacervation at 200× magnification with a scale line at 20 μm.

FIG. 4 is an optical micrograph of exemplary microcapsules produced by complex coacervation at 200× magnification with a scale line at 20 μm.

FIG. 5 is a schematic of an exemplary fluorometer; and

FIG. 6 is an exemplary excitation spectrum and emission spectrum of the fluorescent indicator (quinine) in a pH environment less than 7.0, and at neutral pH of 7.0.

### DETAILED DESCRIPTION

The present disclosure relates to an impact indicator. The impact indicator may include a plurality of microcapsules that incorporate the indicator (e.g. a chemical component) which may be released due to mechanical (e.g. impact) forces. Upon release of the indicator from the microcapsule, the indicator may specifically fluoresce upon exposure to a light source of a specified wavelength (λ). The fluorescence may be activated or promoted by regulating the pH of the environment in which the indicator has been released when applied to a given surface for impact inspection. Regulation of pH may be accomplished, e.g., by combining the microcapsules in a medium which provides a desired pH (e.g. a coating fluid) and/or by separately encapsulating a pH activator in a microcapsule which may also be released upon impact.

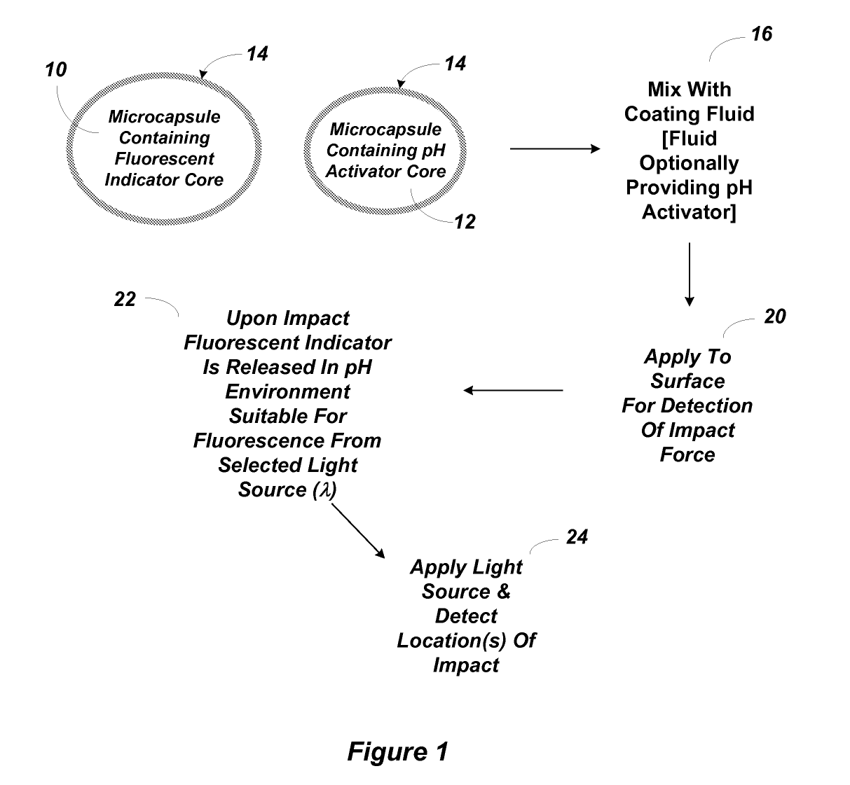

FIG. 1 illustrates the exemplary process of the present disclosure. A microcapsule containing the fluorescent indicator core is shown at 10, along with a microcapsule that may contain a pH activator core 12. Although the microcapsule containing the pH activator is illustrated as relatively smaller in diameter than the microcapsule containing the fluorescent indicator, it may be appreciated that this may be adjusted as desired, which is discussed more fully below. In addition, the microcapsules contain a shell layer illustrated generally at 14 whose thickness may also be selectively adjusted. The microcapsules may then be mixed at 16 with a suitable coating fluid for a selected surface and applied to the surface at 18 for impact detection. When the surface is then impacted such that a mechanical force is developed to rupture the microcapsule, as shown at 20, the fluorescent indicator may then be released along with the pH activator. At 22 one may then apply an appropriate light source for the fluorescent indicator, which may then indicate the location or locations where an impact may have occurred. It may therefore be appreciated that the pH activator within a microcapsule is an optional component, and as illustrated, such activator may be incorporated directly into the coating fluid in a non-microencapsulated form. Furthermore, it is contemplated herein that the pH activator is one that may provide a pH greater than 7.0 or less than 7.0, thereby providing either a relatively basic or acid environment to promote fluorescence, upon release, of the fluorescent indicator.

The microcapsules herein may be understood as having a core containing the fluorescent indicator and/or pH activator and a shell. In addition, it is contemplated that both the indicator and activator may be combined and form a microcapsule core component. In any of these situations, the microcapsules may have a diameter (largest cross-section thickness) in the range of 1 μm to 1,000 μm, including all values and increments therein. Accordingly, microcapsules may be prepared containing the fluorescent indicator having one size, and the microcapsules may be prepared containing the pH activator, where either may have a diameter selected from the indicated range. In addition, the microcapsule shell itself may have a thickness in the range of about 0.001 μm to about 100 μm, including all values and increments therein. Therefore, it is contemplated herein that the thickness of the microcapsule containing the fluorescent indicating core and/or the microcapsule containing the pH activator may be similarly adjusted within this range. Accordingly, the present invention contemplates that the microcapsules may have shells that may respond differently depending upon the relative impact force that may be provided to a given substrate. In such manner the impact detection procedure of the present disclosure may also provide information regarding the relative force of relatively different impacts at varying surface locations.

The microcapsules herein may be prepared by a variety of techniques. For example, the microcapsules may be prepared by interfacial polymerization and/or simple coacervation. With respect to interfacial polymerization, two reactants may be configured at an interface to react, wherein such compounds may include, e.g. an acid chloride and a compound containing an active hydrogen atom, such as an amine or alcohol. More specifically, the microcapsules may be formed via interfacial polymerization by providing an aqueous solution of the indicator and a first reactant to form an aqueous mixture. The aqueous mixture may be emulsified into a solvent (e.g. xylene or heptanes). A second reactant, which may be dissolved in a solvent and may optionally include surfactants, may be added to form a shell at the interface of the dispersed oil droplets and the bulk solvent. Accordingly, the first reactant may include, for example, an amine terminated or hydroxyl terminated polymer and the second reactant may include, for example, a polyisocyanate, which may be aromatic or aliphatic in nature. A polyurethane or polyurea type shell may then be formed at the interface to provide the microcapsule structure.

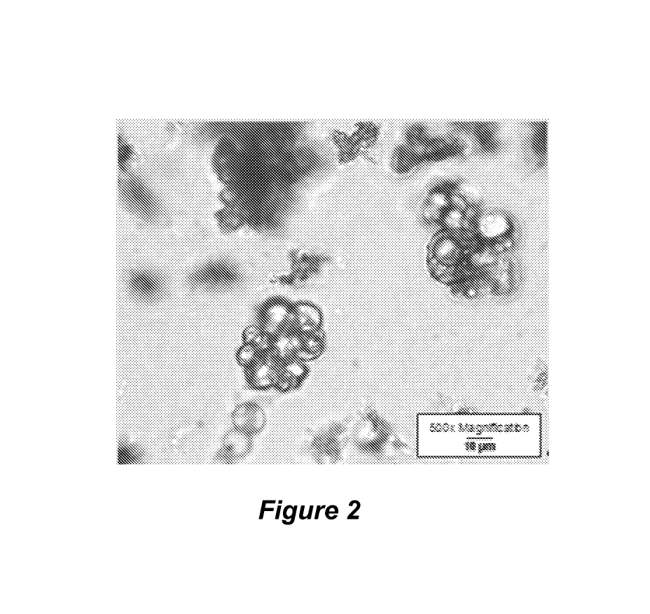

By way of a working example, a shell solution may be prepared by mixing 200 mL of toluene saturated with water with 2.5 grams of poly(4,4′-diphenylmethane diisocyanate) and 1 gram of sorbitan trioleate which may be available from Sigma Aldrich under the designation SPAN 85. A core solution may be prepared with 10 mL of deionized water saturated with quinine (a fluorescent indicator described more fully below) and 1 gram of poly(vinyl alcohol). The core solution was homogenized in 80 mL of water-saturated heptanes. The emulsion may be slowly added to the 200 mL of toluene solution. The reaction may be stirred overnight at room temperature to form microcapsules including a polyurethane shell. FIG. 2 is an optical micrograph of exemplary microcapsules produced via interfacial polymerization.

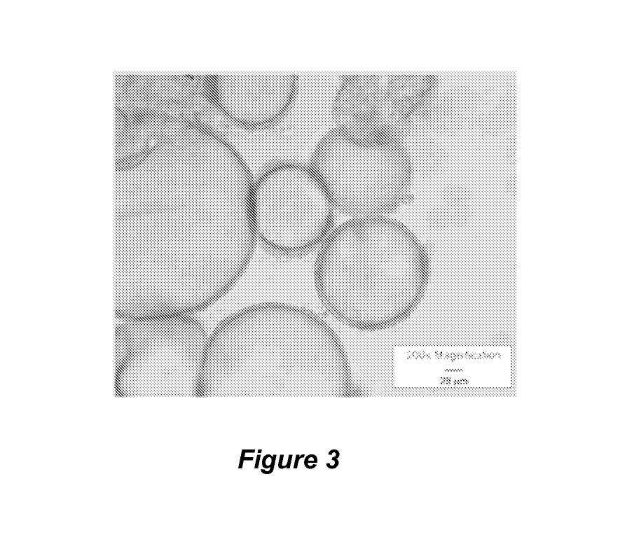

Simple coacervation may include providing a core material of a solvent and an indicator, which may be dispersed into a heated solution of ethylcellulose and polyethylene mixed in a solvent. For example, the shell may be formed from 250 mL of cyclohexane and may be warmed to approximately 80° C. and mixed with 5 grams of low molecular weight polyethylene (such as Polywax 500), 5 grams of ethylcellulose (such as Ethocel® available from Dow Chemical of Midland, Mich.), and 10 grams of sorbitan trioleate. The core may be provided as 20 grams of glycerin containing 1% by weight quinine, which may be homogenized into the cyclohexane mixture. The cyclohexane mixture may then be allowed to slowly cool to room temperature forming the microcapsules. FIG. 3 is an optical micrograph of exemplary microcapsules produced via simple coacervation.

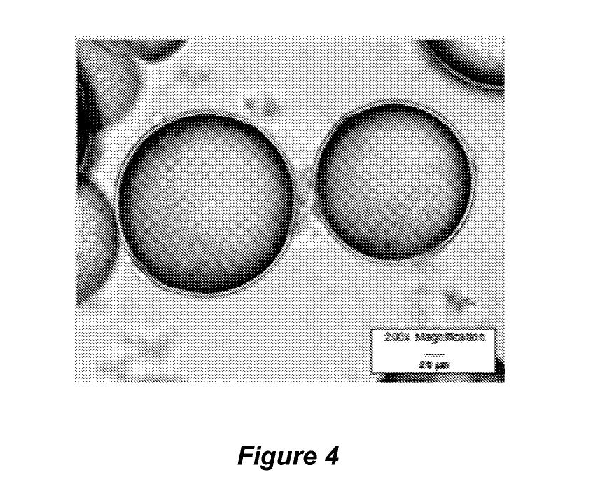

Complex coacervation may include providing a core material of the indicator in a solvent, such as toluene, xylene and tung oil, with ethylcellulose. The core material may then be emulsified into an aqueous solution of gelatin. To this mixture is added a polyphosphate. Then the pH of the reaction may be adjusted to 4.8. Further pH adjustment may be provided to quench activation of the indicator. A crosslinking agent may also be added to crosslink the microcapsule shells. For example, complex coacervation may be carried out by preparing a core material with 35 grams of toluene, 1 gram of ethylcellulose and 1 gram of quinine. The mixture may be emulsified into 400 mL of pH 8.0 deionized water containing 9 grams of 300 Bloom Type A gelatin at 60° C. 20 mL of a 5% polyphosphate solution may be added and then the pH of the reaction mixture may be adjusted to 4.8 using 10% acetic acid. The reaction may be cooled to room temperature and microcapsules may be formed. In addition 5 mL of 25% gluteraldehyde may be added to crosslink the microcapsule gelatin shell. FIG. 4 is a micrograph of exemplary microcapsules produced via complex coacervation.

The fluorescent indicators herein may include any compound that may be included as the core component of the microcapsule and which are capable of providing fluorescence upon exposure to a selected excitation source and when dispersed in a selected pH environment. Accordingly, the fluorescent indicators herein may have no fluorescent capability when encapsulated, while having the ability to fluoresce when released from the microcapsules into a controlled pH environment. It may therefore be appreciated that electromagnetic energy may be emitted from the excitation source and may therefore be in the form of light waves at a given wavelength (λ). The electromagnetic energy may be illuminated onto the released fluorescent indicator and lead to luminescence wherein the molecular absorption of photons by the indicator may trigger the emission of another photon that may be at longer or different wavelengths having varying degrees of intensity. Luminescence may generally refer to and include both fluorescent and phosphorescent effects. Fluorescence may be understood as relatively fast luminescence, exhibiting decay on the order of nanoseconds to microseconds (e.g. the half-life decay of the fluorescent light may be about 25-30 nanoseconds or less). Phosphorescence may be understood as luminescence exhibiting a relatively longer emission of the electromagnetic energy.

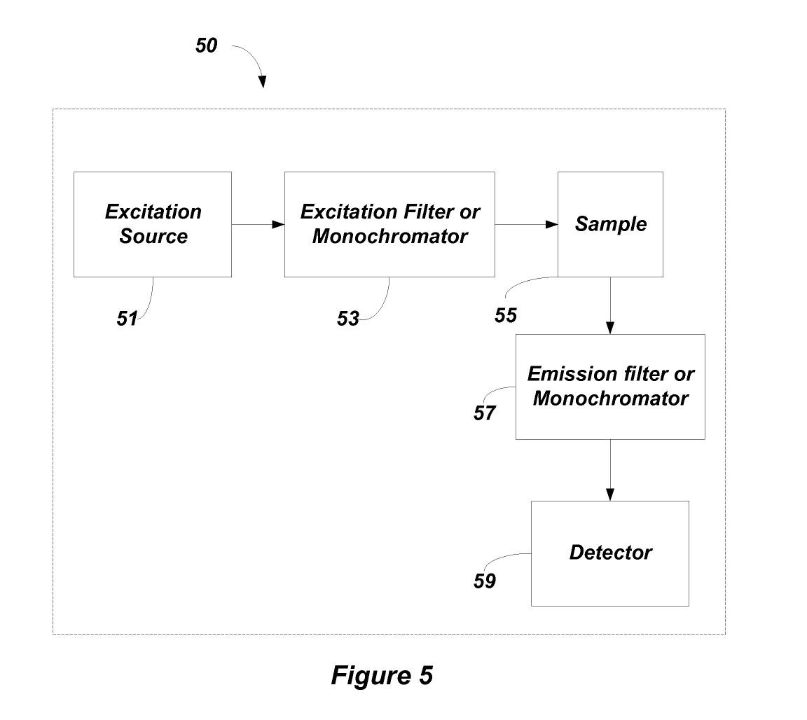

Fluorescence or fluorescent spectra may be measured via a number of measurement techniques, including fluorescence spectroscopy, also known as fluorometry or spectrofluorometry. Such measurement techniques may involve exposing a sample to light of a given spectrum or wavelength, typically in the UV spectrum, and then measuring light emitted from the sample. The instrumentation may include filters or diffraction grating monochromators to isolate the incident and fluorescent light. Furthermore, these techniques may be used to measure the concentration of a fluorescence substance in a solution. FIG. 5 illustrates an exemplary schematic of a fluorometer 50 including an excitation source 51, an excitation filter or monochromator 53, a sample 55, an emission filter or monochromator 57 and a detector 59. In addition, it may be appreciated that fluorescence may be observed with a portable UV device and human observation without the aid of spectroscopy.

The fluorescent indicators herein may therefore be sourced from a variety of compounds, such as those compounds that may be excited by ultraviolet lights (λ=270-400 nm). Expanding upon the above, the fluorescent indicators herein may include those whose fluorescence may be specifically activated or promoted by regulating the pH of its environment. One specific example includes (2-ethenyl-4-azabicyclo[2.2.2]oct-5-yl)-(6-methoxyquinolin-4-yl)-methanol, C₂₀H₂₄N₂O₂, known as quinine, which has the following general formula:

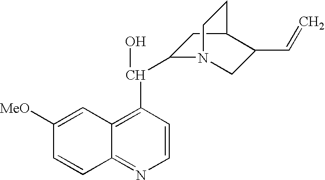

In particular, the fluorescence of quinine may be promoted in acidic conditions (pH<7.0) as opposed to basic conditions (pH>7.0) where the relative fluorescence may be negligible. The fluorescent indicators utilized in the microcapsules may therefore include those which are activated by pH control, wherein the pH may be adjusted so that the fluorescent activator may be exposed to either a relatively acidic or relatively basic surroundings. For example, in the case of quinine, it has been found that the pH activator may include organic acids, such as acetic acid, which has a pKa of about 4.75. Accordingly, it is contemplated herein that the pH activators herein may include acids having pKa values of equal to or greater than about 1.0. For example the pKa values contemplated herein include values of about 1.0 to about 10.0, including all values and increments therein. In addition, one may also employ a dilute inorganic acid, wherein the acid may be present in an amount of less than or equal to about 10% by weight in water. Exemplary inorganic acids include sulfuric acid, nitric acid, hydrochloric acid, etc. Accordingly, one may employ dilute sulfuric acid which may provide a suitable adjustment in pH to promote quinine fluorescence. It may therefore be appreciate that fluorescent indicators herein may remain relatively undetectable upon exposure to a light source unless the indicator is activated by pH adjustment of the surrounding medium.

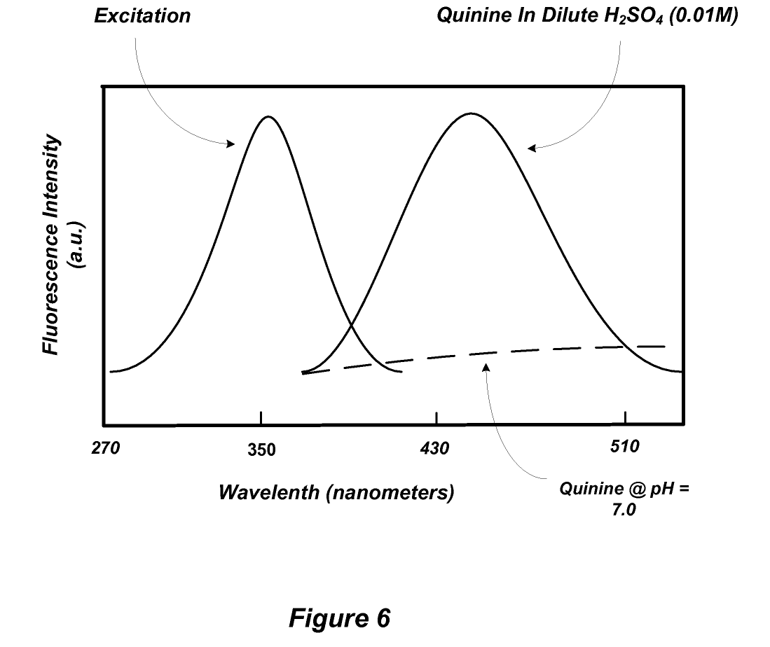

As illustrated in FIG. 6, in the case of quinine in the presence of dilute sulfuric acid, it has been observed that upon excitation with light energy with the indicated wavelength in the range of about 270-400 nanometers, a fluorescence emission is developed which shows a peak fluorescence intensity (arbitrary units) at a wavelength of about 400-500 nanometers, including all values and increments therein. Such fluorescence in a relatively acidic pH environment (pH<7.0) is therefore observed to be different and relatively higher than the fluorescence that may be observed when at relatively neutral pH of about 7.0.

As noted above, the microcapsules containing the fluorescent indicating core and/or the activator may be provided in a paint or a coating material. The paint or coating material may then be applied to a surface. Accordingly, a paint or coating material may be understood as a liquid medium which may be combined with the microcapsules and which may form a solid film coating on a substrate surface due to drying (loss of solvent) or chemical reaction. Exemplary surfaces herein include relative large building structures, aircraft and/or military equipment. The impacts contemplated herein include any impact sufficient to rupture and release the fluorescent indicator, such as a projectile. Any suitable paint or coating liquid is therefore contemplated, including, e.g., latex type formulations, non-latex (e.g. organic solvent based systems) and/or reactive coatings which, as noted, may react upon application and form, e.g. a crosslinked polymeric type protective surface. The film or coating so produced may also be one that will also allow the fluorescent indicator, upon release into a pH controlled environment, to be exposed to the excitation source so that fluorescent detection may proceed along with identification of one or more impact regions.

The foregoing description is provided to illustrate and explain the present invention. However, the description hereinabove should not be considered to limit the scope of the invention set forth in the claims appended hereto.

What is claimed is:

1. A composition capable of detecting impact upon a structure comprising:
microcapsules containing a fluorescent indicator capable of fluorescence, wherein said fluorescent indicator is capable of a first fluorescence intensity (F₁) at a pH of about 7.0 and a second fluorescence intensity (F₂) at a pH value of less than 7.0, wherein F₂>F₁; and
microcapsules containing a pH activator, wherein said pH activator upon release from said microcapsule is capable of providing a pH environment of <7.0 for said fluorescent indicator.

2. The composition of claim 1 wherein said microcapsules have a diameter of about 1 μm to about 1000 μm.

3. The composition of claim 1 wherein said microcapsules have a shell encapsulating said fluorescent indicator or said pH activator having a thickness of about 0.001 μm to about 100 μm.

4. The composition of claim 1 wherein said pH activator in said microcapsules includes an acid having a pKa value of greater or equal to about 1.0.

5. The composition of claim 4 wherein said pKa value is between about 1.0 to about 10.0.

6. The composition of claim 1 wherein said pH activator comprises an inorganic acid.

7. The composition of claim 1 wherein said fluorescent indicator comprises quinine having the formula:

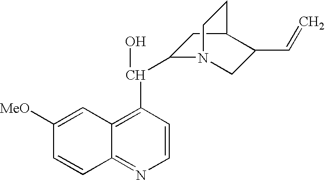

8. The composition of claim 1 wherein said fluorescent indicator comprises quinine and said pH activator comprises acetic acid.

9. A composition capable of detecting impact upon a structure comprising:
microcapsules containing a fluorescent indicator capable of fluorescence, wherein said fluorescent indicator is capable of a first fluorescence intensity (F₁) at a pH of about 7.0 and a second fluorescence intensity (F₂) at a pH value of less than 7.0, wherein F₂>F₁; and
a liquid medium containing a pH activator, wherein said pH activator is capable of providing a pH environment of <7.0 for said fluorescent indicator when released from said microcapsules wherein said fluorescent indicator provides an indication of an impact location.

10. The composition of claim 9 wherein said microcapsules have a diameter of about 1 μm to about 1000 μm.

11. The composition of claim 9 wherein said microcapsules have a shell encapsulating said fluorescent indicator or said pH activator having a thickness of about 0.001 μm to about 30 μm.

12. A composition capable of detecting impact upon a structure comprising:
microcapsules containing a fluorescent indicator comprising quinine having the formula: 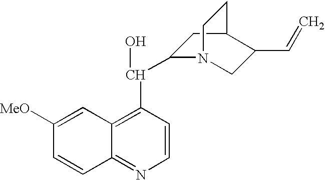
wherein said microcapsules have a diameter of about 1 μm to about 1000 μm wherein said quinine is capable of a first fluorescence intensity (F₁) at a pH of about 7.0 and a second fluorescence intensity (F₂) at a pH value of less than 7.0, wherein F₂>F₁; and
microcapsules containing a pH activator, wherein said pH activator upon release from said microcapsule is capable of providing a pH environment of <7.0 for said quinine, wherein said pH activator has a pKa of greater than about 1.0.

13. A method for revealing an impact received by a structure comprising:
applying to a substrate microcapsules containing a fluorescent indicator capable of fluorescence wherein said fluorescent indicator is capable of a first fluorescence intensity (F₁) at a pH of about 7.0 and a second fluorescence intensity (F₂) at a pH value not equal to 7.0, wherein F₂>F₁;
a pH activator, wherein said pH activator is capable of providing a pH environment not equal to 7.0 for said fluorescent indicator;
wherein upon release of the fluorescent indicator from said microcapsules an area of impact is identified by exposure of said fluorescent indicator to electromagnetic energy to provide fluorescence.

14. The method of claim 13 wherein said pH activator is contained in a microcapsule.

15. The method of claim 13 wherein said microcapsules have a diameter of about 1 μm to about 1000 μm.

16. The method of claims 13 wherein said pH activator comprises an acid having a pKa value of greater or equal to about 1.0.

17. The method of claim 13 wherein said pH activator comprises an inorganic acid.

18. The method of claim 13 wherein said pH activator comprises quinine having the following structure:

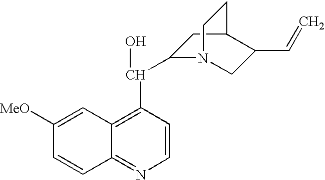

19. The method of claim 13 wherein said fluorescent indicator comprises quinine and said pH activator comprises acetic acid.
